(19) United States
(12) Patent Application Publication
(10) Pub. No.: US 2012/0012242 A1
(43) Pub. Date: Jan. 19, 2012

(54) METHOD AND SYSTEM FOR MATERIAL PLACEMENT OVER RADIUSED EDGES

(75) Inventors: Bradley John Blonigen, Wichita, KS (US); Daniel Richard McBrady, Wichita, KS (US)

(73) Assignee: Spirit AeroSystems, Inc., Wichita, KS (US)

(21) Appl. No.: 12/836,247

(22) Filed: Jul. 14, 2010

(51) Int. Cl. B29C 70/38; B29C 70/08

(52) U.S. Cl. 156/180; 156/212; 156/433

(57) ABSTRACT

A system and method for placement of a strip of material onto a three-dimensional surface having a first face and a second face, with a first radiused edge connecting the first face with the second face. The method may comprise placing one or more strips of material onto the three-dimensional surface along a predefined path requiring various amounts of steering of the strip of material. The method may specifically involve steering the strip of material by a first amount on the first face, steering the strip of material by a second amount on the first radiused edge, and steering the strip of material by a third amount on the second face. The first and/or third amounts may be greater than or equal to the second amount, limiting the amount of steering as the material transverses the first radiused edge.

### BACKGROUND

1. Field

Embodiments of the present invention relate to a method and system for forming a composite part. More particularly, the present invention relates to a method of steering strips of material during composite fiber placement to form a three-dimensional composite part.

2. Related Art

In the art of composite fiber placement, strips of composite tow may be placed on three-dimensional tool surfaces having a plurality of faces joined at radiused or rounded edges to form a three-dimensional part. Each face may have a different primary orientation. A primary orientation as used herein is defined relative to a rosette corresponding with load paths and various engineering requirements of the part.

However, a primary orientation of a second face may be at a different angle relative to the primary orientation of a first face.

During fiber placement, the strips are typically laid onto the tool surfaces at a zero, 45, or 90 degrees relative to the primary orientation of each face. Specifically, the strip can be oriented at a first angle relative to a first primary orientation when placed on the first face, correctively steered across the radiused or rounded edge, and oriented at a first angle relative to a second primary orientation on the second face. This prior art method keeps strips in similar alignment with the primary orientations of each face to allow for standardized testing of each resulting part.

FIG. 1 illustrates an approach for laying a strip of composite tow onto a tool surface during composite fiber placement. Notice that steering primarily occurs as the strip of material or tow is placed onto the radiused edge (R), and with minimal steering applied while the strip of material is placed onto the first face (Q) and the second face (S). The rosettes of the first face (Q) and the second face (5) are off axis relative with each other, so turning or corrective steering as the material crosses the radiused edge (R) is used to maintain a desired angle relative to the primary orientations of each face. FIG. 2 illustrates the strip of material's alignment deviation from the primary orientation of each face with line (L1). The x-axis corresponds with the distance along the tool surface being covered by the strip of material, and the y-axis corresponds with an angle of deviation relative to the primary orientation at that point on the tool surface. In this example, the strip of material spans approximately 6 inches of the first surface (Q), then approximately 2 inches of the radiused edge (R), and then approximately 6 inches of the second surface (S). Note that the strip of material does not deviate from the primary orientation of the first or second faces, so the line (L1) is located on the x-axis of this chart.

In FIG. 3, the x-axis corresponds with the distance being covered by the strip of material on the tool surface and the y-axis corresponds with units of steering or an amount of steering at a particular point on the tool surface. For example, zero units of steering corresponds to no steering, and the greater the units of steering, the greater the amount at which the strip of material is turned or steered. In FIG. 3, significant steering only occurs during placement on the radiused edge (R), with little to no steering occurring as the strip of material is placed on the faces (Q,S), as illustrated on the graph by a line (L2). So the amount of steering as the strip of material is placed onto the radiused edge (R) is greater than the amount of steering on each face (Q,S) of the tool surface.

### SUMMARY

Embodiments of the present invention provide a distinct advance in the art of manufacturing composite parts.

A method of the present invention may comprise steering a strip of material by a first amount on a first face of a fabrication tool, steering the strip of material by a second amount on a first radiused edge of the fabrication tool, and steering the strip of material by a third amount on a second face of the fabrication tool. The first and third amounts may be equal to or greater than the second amount. In some embodiments of the invention, the strip of material may be steered by a smaller amount on the first and/or second radiused edges, but may be steered by a larger amount on the first, second, and/or third face of the fabrication tool's surface. In some embodiments of the invention, the strip of material is steered by approximately zero degrees on the radiused edges.

A system for manufacturing composite parts according to embodiments of the present invention may comprise a processor and a fiber placement apparatus.

The fiber placement apparatus may steer and place strips of material onto a three-dimensional surface of a fabrication tool. The surface of the fabrication tool may have a first face, a second face, and/or a third face. The first and second faces may be connected at a first radiused edge while the second and third faces may be connected at a second radiused edge.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the embodiments and the accompanying drawing figures.

### DESCRIPTION OF THE DRAWINGS

Embodiments of the present invention are described in detail below with reference to the attached drawing figures, wherein:

FIG. 1 is a schematic diagram of a prior art steering path for a strip of material placed over a radiused edge;

FIG. 2 is a graph of an amount of deviation of the steering path in FIG. 1 from a defined 90-degree orientation;

FIG. 3 is a graph of an amount of steering on a first surface, the radiused edge, and a second surface, with the greatest amount of steering occurring over the radiused edge;

FIG. 4 is a schematic elevation view of a system constructed in accordance with an embodiment of the present invention;

FIG. 5 is an exploded perspective view of the fabrication tool of the system of FIG. 4 and a composite part formed thereon;

FIG. 6 is a flow chart of a method of the present invention;

FIG. 7 is a schematic diagram of a steering path for a strip of material placed over a second radiused edge of the fabrication tool of FIG. 5;

FIG. 8 is a graph of an amount of deviation of the steering path in FIG. 7 from a defined orientation;

FIG. 9 is a graph of an amount of steering on a second face, the second radiused edge, and a third face of the fabrication tool of FIG. 5, with the least amount of steering occurring over the second radiused edge;

FIG. 10 is a schematic plan view of the fabrication tool of FIG. 5, illustrating transition areas on either side of the radiused edges;

FIG. 11 is a schematic diagram of a steering path for a strip of material placed over the second radiused edges of the fabrication tool of FIG. 5;

FIG. 12 is a graph of an amount of deviation of the steering path in FIG. 11 from a defined orientation;

FIG. 13 is a graph of an amount of steering on the second face, the second radiused edge, and the third face of the fabrication tool of FIG. 5, with an equal amount of steering on the second face, the second radiused edge, and the third face;

FIG. 14 is a perspective view of the fabrication tool of FIG. 5 with a plurality of strips of material placed thereon in a defined orientation relative to the second face in accordance with one embodiment of the invention; and

FIG. 15 is a perspective view of the fabrication tool with a plurality of strips of material placed thereon in defined orientations relative to the first face and the third face in accordance with another embodiment of the invention.

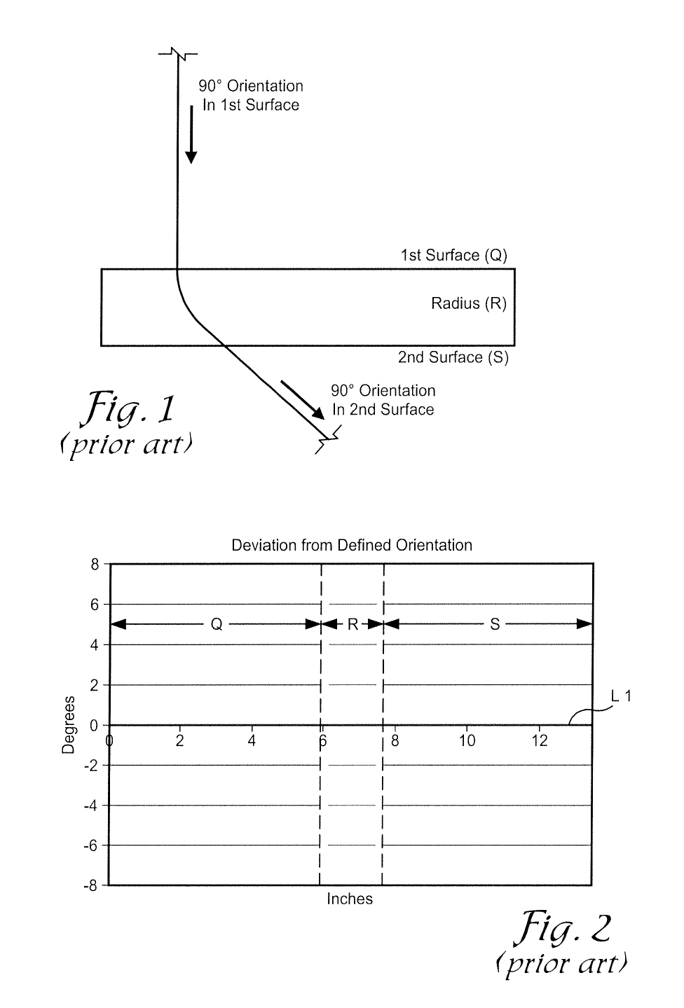

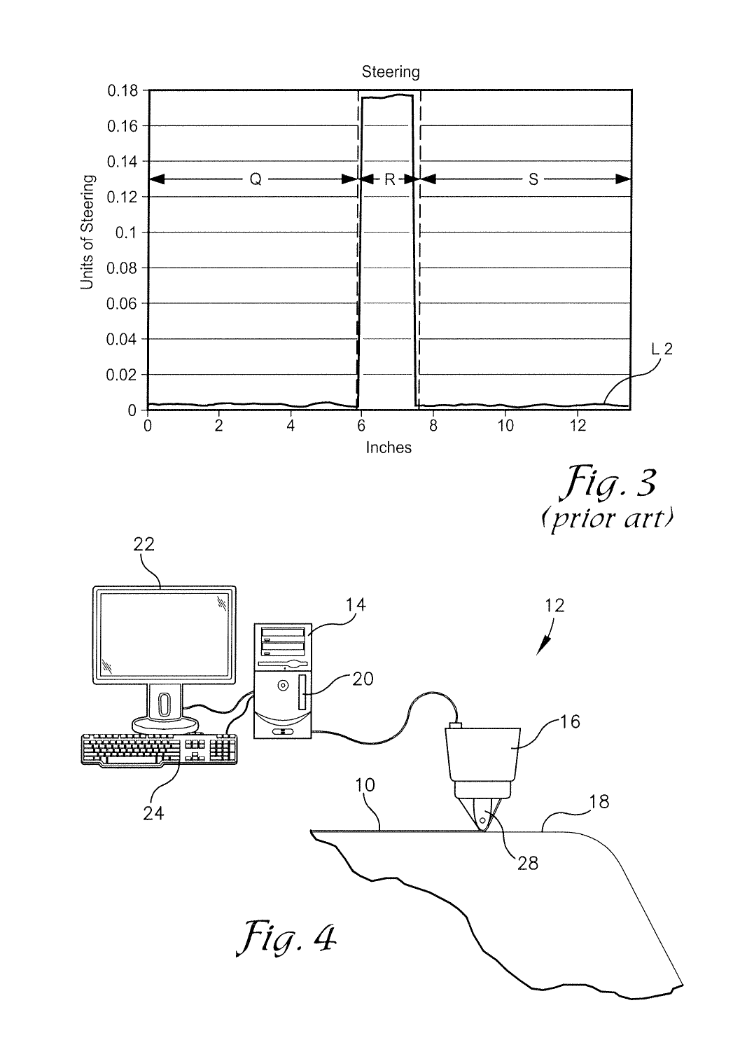

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

The applicant has discovered that steering a strip of material such as composite tape or tow above a certain threshold amount, particularly on radiused or rounded edges, creates buckling and/or fiber distortion in the strip of material, thereby weakening the resulting part. Embodiments of the present invention solve this problem and provide a distinct advance in the art of composite fiber placement on three-dimensional surfaces.

In accordance with various embodiments of the present invention, the system and method described herein may be used for placing one or more strips of material 10 over three-dimensional fabrication tool surfaces while exacting a minimum amount of steering as the strip passes over a radiused edge having a tight radius relative to the overall geometry of a resulting part. This method is particularly useful for making a composite part 25 having a radiused edge that is not parallel or perpendicular to a primary orientation of a face of the composite part. For example, the system and method described herein may be used to form composite parts such as composite wing spars, composite floor beams, composite frames, and the like by way of composite fiber placement onto a fabrication tool.

The strips of material 10 may be strips of composite material, composite tape, and/or composite tow, and/or any other substantially formable material. The width, lengths, and thickness of the strips of material 10 may vary depending on the specifications of the composite part 25 to be formed. In some embodiments of the invention, the strips of material may have a width of 0.01 inches to 1 inch or a width between 0.1 and 0.5 inches. For example, the strips of material may be approximately 0.25 inches wide.

As illustrated in FIG. 4, a system 12 for performing methods of the present invention may comprise a processor 14 and a fiber placement apparatus 16, which may place and layer the strips of material 10 onto a fabrication tool 18. The processor 14 may comprise any number of processors, controllers, integrated circuits, programmable logic devices, or other computing devices and resident or external memory for storing data and other information accessed and/or generated by the system 12. The processor 14 may be coupled with or integral to a memory 20, at least one display 22, a user interface 24, the fiber placement apparatus 16, and other components through wired or wireless connections, such as a data bus (not shown), to enable information to be exchanged between the various components.

The processor 14 may implement a computer program and/or code segments to perform the functions and method described herein. The computer program may comprise an ordered listing of executable instructions for implementing logical functions in the processor 14. The computer program can be embodied in any computer readable medium for use by or in connection with an instruction execution system, apparatus, or device, and execute the instructions. In the context of this application, a “computer readable medium” can be any means that can contain, store, communicate, propagate, or transport the program for use by or in connection with the instruction execution system, apparatus, or device. The computer readable medium can be, for example, but not limited to, an electronic, magnetic, optical, electro magnetic, infrared, or semi conductor system, apparatus, device or propagation medium. More specific, although not inclusive, examples of the computer readable medium would include the following: a portable computer diskette, a random access memory (RAM), a read only memory (ROM), an erasable, programmable, read only memory (EPROM or flash memory), and a portable compact disk read only memory (CDROM).

The memory 20, may be integral with the processor 14, stand alone memory, or a combination of both. The memory may include, for example, removable and non removable memory elements such as RAM, ROM, flash, magnetic, optical, USB memory devices, and/or other conventional memory elements. The memory 20 may store various data associated with the operation of the system 12, such as the computer program and code segments mentioned above, or other data for instructing the processor 14 and system elements to perform the steps described herein. Furthermore, the memory 20 may store, for example, primary orientations and/or rosettes for each face of the fabrication tool 18 and/or the composite part 25, desired orientations of one or more strips of material, steering instructions or paths defined and/or calculated for each strip of material, threshold limits for steering on particular portions of the fabrication tool 18, and the like. The various data stored within the memory 20 may also be associated within one or more databases to facilitate retrieval of the information.

The display 22 may comprise conventional black and white, monochrome, or color display elements including CRT, TFT, LCD, and/or LED display devices. The display 22 may be integrated with the user interface 24, such as in embodiments where the display 22 is a touch screen display to enable the user to interact with it by touching or pointing at display areas to provide information to the system 12. The display 22 may be coupled with the processor 14 and may be operable to display various information corresponding to the system 12 and the fiber placement apparatus 16, such as an amount of material applied to the fabrication tool 18.

The user interface 24 may enable users to share information with the system 14 and the fiber placement apparatus 16. The user interface 24 may comprise one or more functionable inputs such as buttons, switches, scroll wheels, a touch screen associated with the display 22, voice recognition elements such as a microphone, pointing devices such as mice, touchpads, tracking balls, styluses, a camera such as a digital or film still or video camera, combinations thereof, etc. Further, the user interface 24 may comprise wired or wireless data transfer elements such as a removable memory including the memory 20, data transceivers, etc., to enable the user and other devices or parties to remotely interface with the system 14. The user interface 24 may also include a speaker for providing audible instructions and feedback.

The fiber placement apparatus 16 may be any fiber placement apparatus or fiber placement machine operable to place one or more of the strips of material 10 onto a surface along a preset, programmed or manually steered path. For example, the fiber placement apparatus 16 may be a numerically controlled (NC) machine which may be programmed to be guided along a predetermined path on the fabrication tool's surfaces. In some embodiments of the invention, the processor 14 may be integral with and/or a component of the fiber placement apparatus 16.

The fiber placement apparatus 16 may also comprise an applicator 28 for feeding, placing, and/or compacting the strips of material 10 onto the fabrication tool 18. The fiber placement apparatus 16 may place one or more of the strips of material 10 onto the fabrication tool at a time and may comprise one or more robotically-actuated components, circuits, sensors, and the like. In some embodiments of the invention, the fiber placement apparatus 16 may be programmed and/or configured to control placement and steering of the strips of material 10. For example, the fiber placement apparatus 16 may be programmed and/or configured to limit or disallow steering of the strips of material 10 as they are each guided over and/or placed onto a radiused edge or corner of the fabrication tool 18, thereby preventing adverse affects to any of the strips of material 10, such as buckling or wrinkling.

The fabrication tool 18, as illustrated in FIG. 5, may be any rigid tooling having a three-dimensional tool surface 30 configured for forming a three-dimensional part, such as the three-dimensional composite part 25. For example, the fabrication tool 18 may be a three-dimensional spar tool surface for fabricating a composite spar for an aircraft. The fabrication tool surface 30 may have a first face 32, a second face 34, and/or a third face 36. The first face 32 may connect with the second face 34 at a first radiused edge 38 and the second face 34 may connect with the third face 36 at a second radiused edge 40. The first face 32 may be bounded by a first side edge 42, two ends 44,46, and the first radiused edge 38. The second face 34 may be bounded by the first radiused edge 38, the second radiused edge 40, and two ends 48,50. The third face 36 may be bounded by the second radiused edge 40, a second side edge 52, and two ends 54,56. In some embodiments of the invention, the radiused edges 38,40 may be located further apart from each other at one of the ends 48 than they are at the opposite end 50. Furthermore, the first face 32 and/or the third face 36 may be angled relative to the second face 34 at any angle. However, the fabrication tool 18 may have any number of faces, radiused edges, curves, and corners in any three-dimensional configuration required for a particular part to be formed therefrom.

The first face 32 and the third face 36 may be configured to form flanges of a wing spar while the second face 34 may be configured to form a web of the wing spar. In some embodiments of the invention, the first and/or second radiused edges 38,40 may have a radius substantially smaller than a total size of fabrication tool 18. The first and/or second radiused edges 38,40 may extend along a substantially straight line or may curve, jut, or angle in various directions along any path as desired to form a particularly shaped part. Furthermore, radiuses of the first and/or second radiused edges 38,40 may not remain the same size throughout a length of the fabrication tool 18. For example, a radius of the first radiused edge 38 may be smaller at a first end than a radius at a second end thereof.

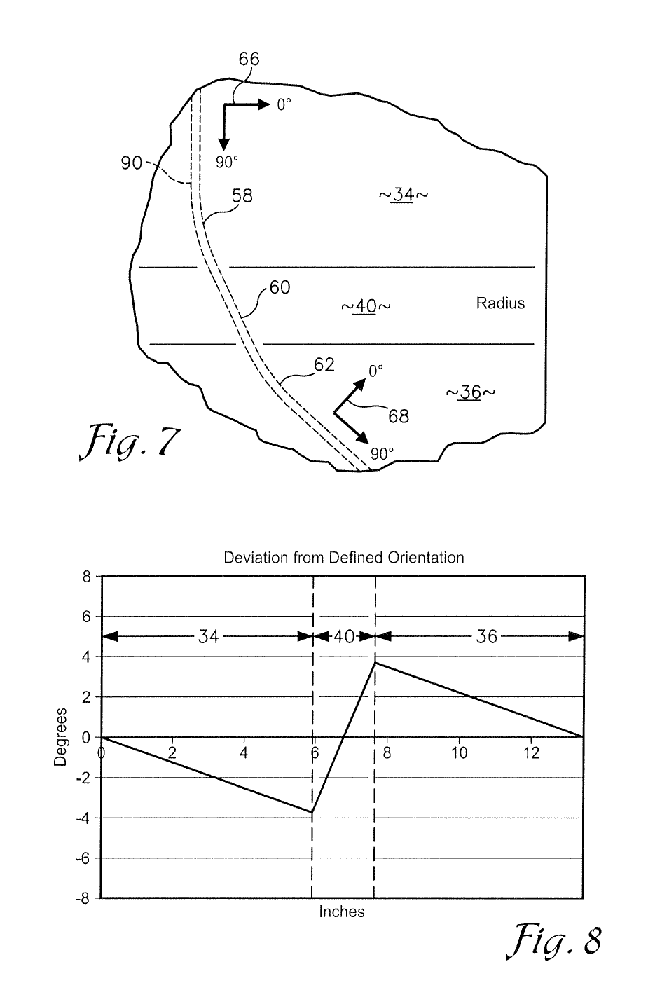

Each of the faces 32-36 may have and/or be assigned a primary orientation or defined orientation for the strips of material 10. The primary orientation is determined based on geometry, load paths, and other engineering requirements of the desired resulting part and/or based on standardized test requirements for a given resulting part. The primary orientations may each be angles relative to a rosette 64,66,68 defined for each of the faces 32-36, as illustrated in FIGS. 7 and 10. The rosettes 64-68 may be compass roses and/or x-y axes establishing zero-degrees and 90-degrees reference orientations for the processor 14 and/or the fiber placement apparatus 16. While the drawing figures herein illustrate the rosettes 64-68 on their corresponding faces 32-36, these rosettes 64-68 may actually be defined by and/or programmed into the processor 14 and/or the fiber placement apparatus 16 without providing any visual reference on the fabrication tool 18.

Each of the rosettes 64-68 may have an x-axis, a y-axis perpendicular to the x-axis, and/or a 45-degree axis extending at a 45-degree angle relative to the x and y axes. Any one of the x-axis, y-axis, or 45-degree axis may be defined as the primary orientation of its corresponding face 32-36. For example, the primary orientations may each be defined as 90-degrees relative to each of the rosettes 64-68. Alternatively, the primary orientations may be defined as zero degrees, +45-degrees, or −45-degrees relative to each of the rosettes 64-68. However, the rosettes 64-68 and/or primary orientations of each of the faces 32-36 may be defined by a user and/or the processor 14 at any angle or orientation relative to the faces 32-36 and to each other according to part requirements and/or established testing standards.

As noted above, the rosettes 64-68 may each be misaligned with each other on the surface 30 due to various factors such as the angles of the radiused edges 38,40 relative to primary orientations of the faces 32-36. Therefore, if a strip of material 10 is placed at a first angle relative to a primary orientation on the first face 32 and is not steered, but rather laid onto the surface 30 in a straight line path, the strip of material may not align with a primary orientation of the second face 34 at the first angle.

In some embodiments of the invention, each strip of material 10 may be steered by a given amount depending on the location of the strip of material relative to the fabrication tool 18. The amount of steering of each of the strips of material 10 as they are placed on at least one of the faces 32-36 may be equal to or greater than the amount of steering of each of the strips of material 10 as they are placed onto the radiused edges 38,40. Specifically, the strips of material 10 may be steered across each of the first face 32, the first radiused edge 38, the second face 34, the second radiused edge 40, then the third face 36 by different steering amounts such that the amount of steering across both of the radiused edges 38,40 may be less than or equal to the amount of steering on each of the faces 32-36.

In exemplary embodiments of the invention, the strip of material 10 may be steered along a path that varies from a first primary orientation on the first face 32 and/or a second primary orientation on a second face 34. Furthermore, the strip of material 10 may be steered on the first radiused edge 38 by an amount below a defined steering threshold at which an undesired amount of buckling occurs. The primary orientation of the first face 32 may not be parallel or perpendicular with the primary orientation of the second face 34. Steering the strip of material 10 results in in-plane bending moments that place an inside edge of the strip of material 10 in compression and an outside edge of the strip of material 10 in tension. The defined steering threshold value is a degree of steering at which these tension and compression loads cause the fibers to distort beyond the acceptable limits as defined by specific engineering or fabrication requirements.

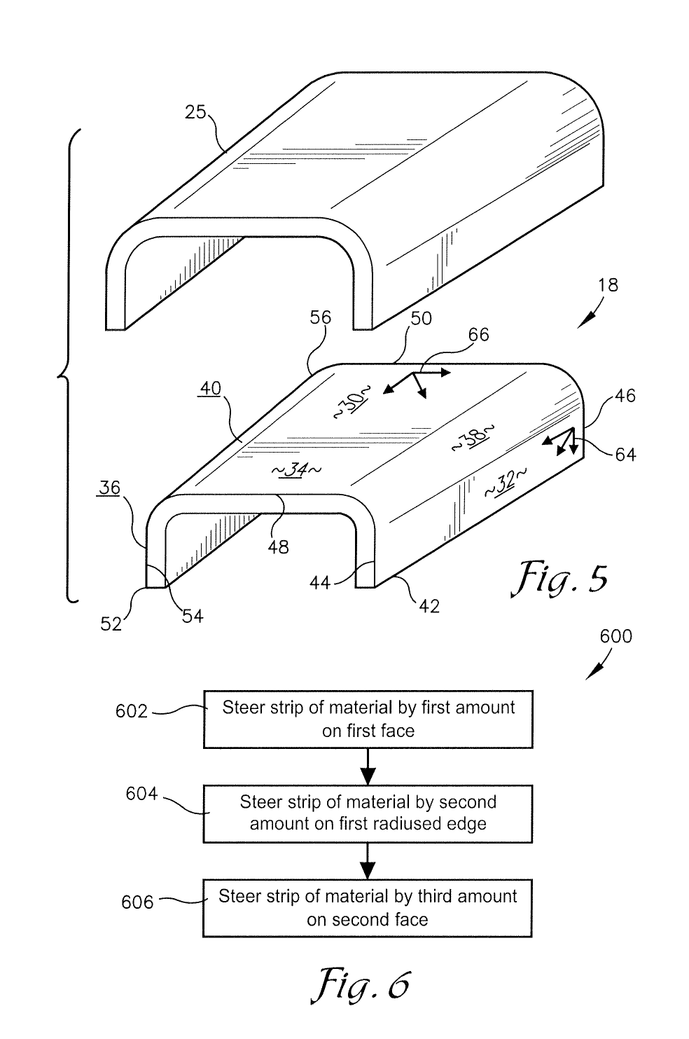

Note that the methods described herein may involve placing the strips of material 10 directly on the fabrication tool 18 and/or onto subsequent layers of previously-placed strips of material 10. For example, steering one of the strips of material 10 on any of the faces 32-36 or the radiused edges 38,40, as described herein, may include steering the strip of material directly onto the fabrication tool 18 or on top of one or more layers of other strips of material previously placed on the corresponding faces 32-36 and/or radiused edges 38,40. The resulting composite part 25, as illustrated in FIG. 5, may be comprised of a plurality of layers of the strips of material 10. As illustrated in FIG. 6, a method 600 of the invention may comprise steering the strip of material 10 by a first amount along at least a portion of the first face 32, as depicted in step 602 and steering the strip of material 10 by a second amount across the first radiused edge 38, as depicted in step 604. The method 600 may further comprise steering the strip of material 10 by a third amount along at least a portion of the second face 34, as depicted in step 606. At least one of the first and third amounts may be greater than or equal to the second amount.

In another embodiment of the invention, as illustrated in FIGS. 7-9, the strip of material 10 may be placed onto the fabrication tool 18 at an approximately 90-degree angle relative to the rosette 66 of the second face 34 and steered right or left by a first amount 58, then steered by a much smaller second amount 60 as the strip of material 10 is placed onto the fabrication tool 18. Then the strip of material 10 may be steered by a third amount 62 as the strip of material 10 is placed onto the third face 38, steering the strip of material into an approximately 90-degree angle relative to the rosette 68. The first amount 58 and the third amount 62 may be greater than or equal to the second amount 60. FIG. 7 illustrates a path 90 on which one of the strips of material 10 may be laid as described above, labeling sections on the path 90 at which steering by the first amount 58, the second amount 60, and the third amount 62 take place.

FIG. 8 illustrates an amount of deviation in the example of FIG. 7 from the primary orientations of each of the second and third faces 34,36. The x-axis corresponds with the distance on the tool surface 30 being covered by the strip of material 10, and the y-axis corresponds with an angle of deviation relative to the primary orientation at a given point on the tool surface 30.

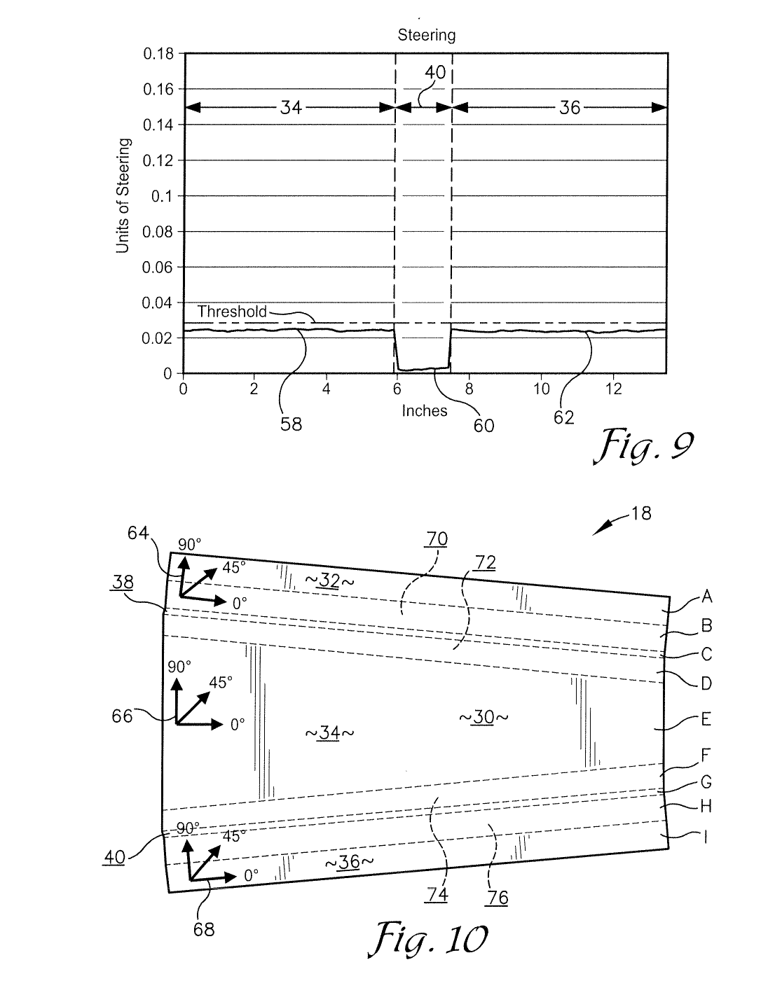

FIG. 9 illustrates a decrease in the amount of steering as at least one of the strips of material 10 are placed over the radius. The x-axis corresponds with a distance being covered by the strip of material 10 on the tool surface 30 and the y-axis corresponds with units of steering or an amount of steering at a particular point on the tool surface 30. Zero units of steering corresponds to no steering, and the greater the units of steering, the greater the amount at which the strip of material is turned or steered. In one embodiment, the units of steering may be a rate at which an angle of the applicator 28 changes as it places the strips of material 10 onto the tool surface 30.

In some embodiments of the invention, the first amount 58 and the second amount 60 of steering may be substantially equal while the third amount 62 is greater than both the first and second amounts 58,60. In other embodiments of the invention, the second and third amounts 60,62 may be equal while the first amount 58 is greater than both the second and third amounts 60,62. Notice in FIG. 9 that the actual amounts of steering 58-62 may each vary slightly over each portion of the fabrication tool 18. For example, the first, second, and third amounts 58-62 of steering may refer to a plurality of amounts within a particular range of steering units and not one precise value or steering amount. The second amount 60 may be equal to zero steering or any other amount of steering below a particular threshold. Furthermore, the first and third amounts 58,62 may also be below the threshold.

The threshold may correspond to an amount of steering at which the strips of material 10 may buckle, wrinkle, stretch, tear, etc. Specifically, the threshold level may correspond with an amount of steering at which a material stretches or buckles beyond a set tolerance level. For example, at the threshold amount of steering, the strip of material may experience tension along an outer edge that is no greater than a desired tension tolerance amount and compression along an inner edge of the strip of material that is no greater than a desired compression tolerance amount. The amounts of steering 58-62 may be limited by the processor 14 and/or the fiber placement apparatus 16 to remain below the threshold level of steering. In some embodiments of the invention, the threshold may be a different amount along at least one of the radiused edges 38,40 than the threshold amount set for the faces 32-36 of the fabrication tool 18. The threshold amount of steering may be determined based on the width of the strips of material 10, the width and radius of the radiused edges 38,40, load requirements of the resulting part, etc.

In some embodiments of the invention, as illustrated in FIG. 10, an amount of steering applied to the strip of material 10 as it is placed onto the fabrication tool 18 may vary over certain areas on the first, second, and/or third faces 32-36. For example, a first transition area 70 on the first face 32, a second transition area 72 on the second face 34, a third transition area 74 on the second face 34, and/or a fourth transition area 76 on the third face 36 may be defined adjacent to the first and second radiused edges 38,40 respectively. The first and second transition areas 70,72 may be adjacent the first radiused edge 38 and the third and fourth transition areas 74,76 may be adjacent the second radiused edge 40.

As illustrated in FIG. 10, the strip of material 10 may be steered by an amount A along the first face 32 until reaching the first transition area 70, at which point the strip of material 10 may be steered by an amount B. Then the strip of material 10 may be steered by an amount C on the first radiused edge 38, then by an amount D on the second transition area 72 until reaching a boundary of the second transition area, at which point the strip of material 10 may be steered by an amount E. In some embodiments of the invention, amount A, amount B, amount C, and amount D may be equal. Alternatively, the amounts B and/or D may be equal to each other and the amounts A, C, and/or E may be equal to each other but different than the amounts B and/or D.

Upon reaching the third transition area 74, the strip of material 10 may be steered by an amount F then subsequently steered by an amount G on the second radiused edge 40 until reaching the fourth transition area 76. The strip of material 10 may be steered by an amount H in the fourth transition area 76 until reaching a boundary thereof, and then may be steered by an amount I across the remainder of the third face 36. The amount F, the amount G, and the amount H may be equal. Alternatively, the amounts F and/or H may be equal to each other and the amounts E, G, and/or I may be equal to each other but different than the amounts F and/or H. In FIG. 10, areas of the fabrication tool 18 are labeled A-I corresponding to the amounts of steering A-I applied thereat. As in previous examples, each of the steering amounts A-I may include any of a plurality of steering amounts within a particular tolerance range.

The strips of material 10 may each be steered in an identical manner. However, in some embodiments of the invention different amounts of steering may be used for one or more of the strips of material 10 placed on and across a single radiused edge. For example, a first strip of material may be steered by a particular amount across the first radiused edge 38 and then a second strip of material may be steered by a different amount across the first radiused edge 38. A portion along a length of the first radiused edge 38 may have a different radius, shape, or curvature than other portions of the first radiused edge, such that a different amount of steering may result in a smaller amount of buckling along that portion of the first radiused edge. Therefore, the amount of steering used for each strip of material may depend on the geometry of the composite part 25 and the threshold amount of steering set for a particular portion of the resulting composite part 25.

In some embodiments of the invention, the strips of material 10 may not be steered while being applied onto the fabrication tool 18, as illustrated in FIGS. 11-14. For example, the strips of material 10 may be laid onto the first face 32, second face 34, and/or third face 36 along a straight line path that is parallel to or in alignment with a primary orientation of the second face 34. In this embodiment of the invention, the strips of material 10 may extend at a primary orientation of 90-degrees relative to the rosette 66 of the second face 34. If the rosettes 64,68 of the first face 32 and/or the third face 36 have axes which are not aligned with an axis of the rosette 66 of the second face 34, then the strips of material 10 in this example will not be parallel with the y-axis of either the rosette 64 of the first face 32 and/or the rosette 68 of the third face 36.

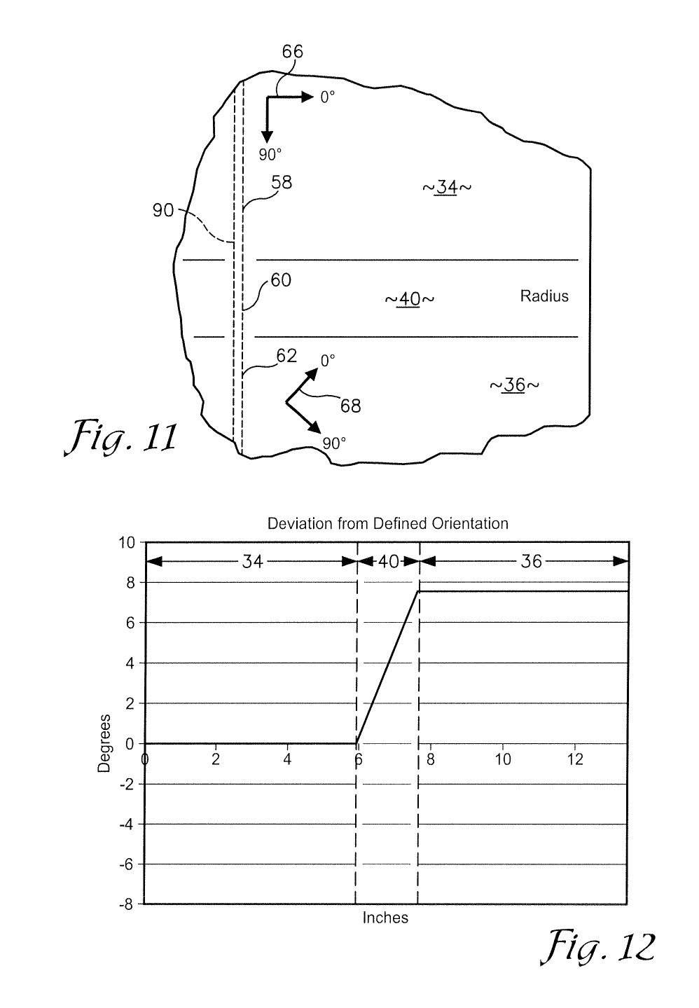

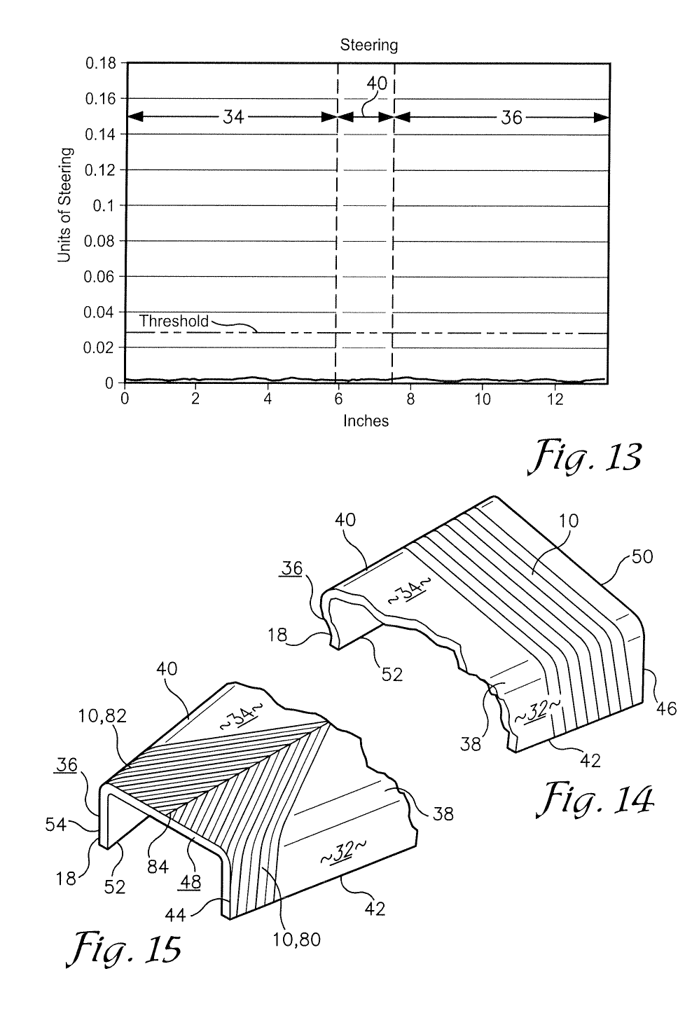

For example, as illustrated in FIG. 11., the path 90 of the strip of material 10 does not turn at any point and is not steered to the right or left. Therefore, the steering amounts 58-62 over the second face 34, the second radius 40, and the third face 36 are approximately zero and equal to each other. FIG. 12 illustrates that the strip of material 10 is aligned with and does not substantially deviate from a 90-degree primary orientation on the second face 34, but does deviate from a 90-degree primary orientation on the third face 36, even though the amount of steering remains at approximately zero across the second face 34, the second radius 40, and the third face 36, as illustrated in FIG. 13. FIG. 14 illustrates a plurality of the strips of material 10 placed onto the fabrication tool 18 with approximately zero steering.

In one example embodiment of the invention, as illustrated in FIG. 15, the system 12 described above may be configured for making a particular shape out of the strips of material 10, such as a composite spar for an aircraft wing. Specifically, a first plurality 80 of the strips of material 10 may be placed onto a three-dimensional spar tool surface, such as the tool surface 30 illustrated in FIG. 15. The first plurality 80 of the strips of material 10 may be placed such that they each align with a primary orientation of the first face 32. The first plurality 80 of the strips of material 10 may extend from the first side edge 42 to a boundary 84 extending between the two ends 48,50 of the second face 34. The fiber placement apparatus 16 may also place a second plurality 82 of the strips of material 10 onto the tool surface 30 such that the strips of material 10 of the second plurality 82 each align with a primary orientation of the third face 36. The second plurality 82 of the strips of material 10 may extend from the second side edge 52 to the boundary 84. The first and second pluralities 80,82 of the strips of material 10 may then be cured to form the shape, such as the hardened composite spar. Note that in this example embodiment of the invention, the strips of material 10 are not aligned with a primary orientation of the second face 34, because the rosette 66 of the second face (and therefore its primary orientation) is not aligned with the rosettes 64,68 nor the primary orientations of the first and third faces 32,36. Although the invention has been described with reference to the embodiments illustrated in the attached drawing figures, it is noted that equivalents may be employed and substitutions made herein without departing from the scope of the invention as recited in the claims. For example, the distance and angle measurements provided in FIGS. 8-9 and 12-13 are merely exemplary and are not intended to limit the scope of the invention as described herein.

Having thus described various embodiments of the invention, what is claimed as new and desired to be protected by Letters Patent includes the following:

1. A method for placement of a strip of material onto a three-dimensional surface having a first face and a second face, with a first radiused edge connecting the first face with the second face, the method comprising:
steering the strip of material by a first amount on at least a portion of the first face;
steering the strip of material by a second amount on the first radiused edge; and
steering the strip of material by a third amount on at least a portion of the second face, wherein at least one of the first and third amounts are greater than or equal to the second amount,
wherein the first, second, and third amounts of steering are below a defined threshold, wherein the threshold corresponds with an amount of steering at which the strip of material stretches or buckles beyond a set tolerance level.

2. The method of claim 1, wherein the second amount and the third amount are equal and the first amount is greater than the second amount and the third amount.

3. The method of claim 1, wherein the first face further comprises a first transition area adjacent the first radiused edge and the second face further comprises a second transition area adjacent the first radiused edge, wherein an amount of steering of the strip of material on the first and second transition areas is equal to the second amount of steering and less than the first and third amounts of steering.

4. The method of claim 1, wherein the first face further comprises a first transition area adjacent the first radiused edge and the second face further comprises a second transition area adjacent the first radiused edge, wherein an amount of steering of the strip of material on the first and second transition areas is greater than the second amount and the amount of steering on the first face and second face outward of the first and second transition areas is equal to the second amount.

5. The method of claim 1, wherein the strip of material is composite tow.

6. The method of claim 1 wherein a fiber placement apparatus steers the strip of material on the three-dimensional surface.

7. The method of claim 1, wherein the three-dimensional surface further comprises a third face and a second radiused edge connecting the second face with the third face, wherein the method of claim 1 further comprises steering the strip of material by a fourth amount on the second radiused edge and steering the strip of material by a fifth amount on at least a portion of the third face of the three-dimensional surface, wherein at least one of the third amount and the fifth amount are greater than or equal to the fourth amount.

8. The method of claim 7, wherein the first, second, third, fourth, and fifth amounts of steering each comprise a range of steering amounts within a tolerance range of steering units.

9. The method of claim 7, wherein the first radiused edge is further away from the second radiused edge at one end of the three-dimensional surface than at an opposite end of the three-dimensional surface.

10. A method for fiber placement of one or more strips of composite material onto a three-dimensional surface having a first face, a second face, and a third face, with a first radiused edge connecting the first face with the second face and a second radiused edge connecting the second face with the third face, the method comprising:
steering a first strip by a first amount on at least a portion of the first face;
steering the first strip by a second amount on the first radiused edge;
steering the first strip by a third amount on at least a portion of the second face, wherein at least one of the first and third amounts are greater than or equal to the second amount;
steering the strip of material by a fourth amount on the second radiused edge; and
steering the strip of material by a fifth amount on at least a portion of the third face, wherein at least one of the third amount and the fifth amount are greater than or equal to the fourth amount,
wherein the first, second, third, fourth, and fifth amounts of steering each comprise one or more amounts within a tolerance range of steering units.

11. The method of claim 10, wherein the second and fourth amounts of steering are equal to approximately zero.

12. The method of claim 10, wherein the first face further comprises a first transition area adjacent the first radiused edge and the second face further comprises a second transition area adjacent the first radiused edge, wherein an amount of steering of the strip of material on the first and second transition areas is equal to the second amount.

13. The method of claim 10, further comprising steering a second strip along the first face, the first radiused edge, and the second face, wherein the second strip is steered on the first radiused edge by a different amount than the second amount.

14. The method of claim 10, wherein the first, second, third, fourth, and fifth amounts of steering are each below a defined threshold, wherein the threshold corresponds with an amount of steering at which the strip of material stretches or buckles beyond a set tolerance level.

15. A fiber placement system for placing strips of material onto a fabrication tool having a surface comprising a first face, a second face, and a radiused edge joining the first face with the second face, the fiber placement system comprising:
a material applicator configured to position and place strips of material onto the surface; and
a processor configured to control steering of the material applicator such that the material applicator steers the strip of material by a first amount along at least a portion of the first face, steers the strip of material by a second amount across the first radiused edge, and steers the strip of material by a third amount along at least a portion of the second face, wherein at least one of the first and third amounts are greater than or equal to the second amount.

16. The fiber placement system of claim 14, wherein the processor is further configured for steering the strips of material such that the strips of material each align at a particular angle relative to a primary orientation of the first face, but do not align at that same particular angle relative to a primary orientation of the second face.

17. A method for placement of a strip of material onto a three-dimensional surface having a first face and a second face, with a first radiused edge connecting the first face with the second face, the method comprising:
steering the strip of material along a path that varies from at least one of a first primary orientation on the first face and a second primary orientation on the second face; and
steering the strip of material on the first radiused edge by an amount below a defined threshold at which an undesired amount of buckling occurs in the strip of material.

18. The method of claim 17, wherein the primary orientation of the first face is not parallel or perpendicular with the primary orientation of the second face.

19. The method of claim 17, wherein the strip of material is steered by a greater amount on at least one of the first face and the second face than the amount by which the strip of material is steered on the first radiused edge.

20. A method for placement of a strip of material onto a three-dimensional surface having a first face and a second face, with a first radiused edge connecting the first face with the second face, the method comprising:
steering the strip of material on the first radiused edge at a level below a defined threshold at which an undesired amount of buckling occurs in the strip of material by increasing the amount of steering on at least one of the first face and the second face.
